(19) United States
(12) Patent Application Publication
(10) Pub. No.: US 2008/0060735 A1
(43) Pub. Date: Mar. 13, 2008

(54) C-SHAPED INNER TUBE FOR TIRES

(76) Inventor: Joseph Taylor, Sumter, SC (US)

Correspondence Address: Quan L. Nguyen;Nguyen & Wimier, PLLC, 6039 E. Grant Road, Tuscon, AZ, 85712, US

(21) Appl. No.: 11/851,967

(22) Filed: Sep. 7, 2007

Related U.S. Application Data
(60) Provisional application No. 60/843,691, filed on Sep. 11, 2006.

(51) Int. Cl. B60C 5/04

(52) U.S. Cl. 152/511

(57) ABSTRACT

The present invention features a C-shaped inner tube for use with a pneumatic tire; the C-shaped inner tube comprises a hermetically sealed compartment comprising a first sealed termination and a second sealed termination and a threaded stem valve disposed on a surface of the hermetically sealed compartment located at a distance that is less than one fourth (¼) of the inner circumference of the C-tube, as measured from the first sealed termination.

### CROSS REFERENCE

This application claims priority to U.S. provisional application Ser. No. 60/843,691 filed Sep. 11, 2006, the specification of which is incorporated herein by reference in its entirety.

### FIELD OF THE INVENTION

The present invention relates to inner tubes, more specifically to an inner tube apparatus for use with a pneumatic tire and method of use.

### BACKGROUND OF THE INVENTION

When a tire of a wheeled transportation device, e.g., a car, a truck, a motorcycle, or a bicycle, breaks or leaks, the traditional way to replace it is cumbersome. Usually, the replacement involves removing the wheel entirely, which is not an easy or safe task to perform, especially if it is on the side of the road with passing traffic.

While replacement inner tubes for tires such as that of US Patent Application 2007/0125470 do not necessitate the removal of the entire wheel assembly, they are also time consuming and inconvenient because, for example, only half of the replacement tube can be inserted into the tire in one motion. (The disclosure of US Patent Application 2007/0125470 is incorporated in its entirety by reference herein.) In other words, once the stem valve has been inserted into the metal frame, the user then feeds through either the first half or the second half of the inner tube into the tire. Once that half has been inserted into the tire, the user must go back and feed through the other half of the tube. Thus, there is a need for a further improved replacement inner tube that allows a user to more quickly and more easily replace the inner tube of a tire without requiring the removal of the wheel assembly.

### BRIEF DESCRIPTION OF THE DRAWINGS

FIG. 1 illustrates a perspective view of the C-shaped inner tube for use with a pneumatic tire in accordance with one embodiment of the present invention.

FIG. 2 illustrates a cross section view of the C-shaped inner tube for use with a pneumatic tire in accordance with one embodiment of the present invention.

FIG. 3 illustrates a perspective view of the C-shaped inner tube for use with a pneumatic tire in accordance with one embodiment of the present invention, wherein the stem valve is closer to the first sealed terminal.

### DESCRIPTION OF PREFERRED EMBODIMENTS

The present invention features a novel C-shaped inner tube 100 for use with a pneumatic tire. In some embodiments, the C-shaped inner tube 100 (for use with a pneumatic tire) comprises a hermetically sealed compartment with a first sealed termination 102 and a second sealed termination 103. The inner tube 100 further comprises a threaded stem valve 105 disposed on the surface of the hermetically sealed compartment in the region of the first sealed termination, and it comprises a threaded stem valve cap 107 that forms a hermetic seal when coupled to the threaded stem valve 105.

Because the C-shaped inner tube 100 has two sealed terminations, it allows for the replacement of an inner tube 100 without requiring that the wheel be completely removed. To exchange the flat tire having an inner tube, the user can simply cut the existing inner tube to remove it from the tire, push the stem valve 105 of the present invention through the stem valve aperture on a tire rim, feed in the C-shaped inner tube 100 of the present invention while spinning the tire in one direction, and, lastly, inflate the inner tube 100. The hermetically sealed compartment will expand when inflated, with the first sealed termination 102 and second sealed termination 103 abutting, forming a contiguous circle with no gap 104.

When a user experiences a flat tire on a wheeled transportation device, e.g., a car, a truck, a motorcycle, or bicycle, the user pulls over to the side of the road. A user may remove inner tube 100 from a compact folded and stored position. A user may remove the old inner tube from the tire by pulling the inner tube out from the tire (e.g., from the rim), without removing the wheel from the wheel assembly. A user then may insert stem valve 105 through the stem valve aperture in the tire. The C-shaped inner tube 100 would then be inserted around the rim of the tire with the wheel assembly still on the wheeled transportation device by spinning the wheel in single direction. The deflated inner tube 100 would then encircle the tire rim with first sealed termination 102 abutting second sealed termination 103. A user would remove the stem valve cap 107 and inflate inner tube 100 by placing an inflator on the open end of stem valve 105. The inflator may be provided in various embodiments including, but not limited to, an air compressor, a hand pump, or canned air. As air fills hermetically sealed compartment 101, inner tube 100 takes on an annular shape as first sealed termination 102 abuts second sealed termination 103 and provides a strong contiguous annular hermetically sealed compartment 101.

In some embodiments, the stem valve 105 is disposed on the surface of the hermetically sealed compartment at a distance that is less than one fourth (¼) of the inner circumference (e.g., the circumference of a circle defined by the “inner wall” 202, see FIG. 2) of the tire from the first sealed termination. (As applied herein, measurements relevant to the distance of the stem valve from the first sealed termination are performed on a fully inflated inner tube 100 where the first termination 102 and second termination 103 abut, and there is no gap 104.) For example, if the inner circumference of the tire is 48 inches, the stem valve 105 is located less than 12 inches from the first sealed termination (¼ of 48 inches). In some embodiments, the stem valve 105 is disposed on the surface of the hermetically sealed compartment at a distance that is less than one eighth (⅛) of the inner circumference of the tire from the first sealed termination. For example, if the circumference of the tire is 48 inches, the stem valve 105 is located less than 6 inches from the first sealed termination (⅛ of 48 inches). In some embodiments, the stem valve 105 is disposed on the surface of the hermetically sealed compartment at a distance that is less than one sixteenth ( 1/16) of the inner circumference of the tire from the first sealed termination. For example, if the inner tube has a circumference of 48 inches, the stem valve 105 is located less than 3 inches from the first sealed termination ( 1/16 of 48 inches). In some embodiments, the stem valve 105 is disposed on the surface of the hermetically sealed compartment at a distance that is less than one fourth (¼) of the inner circumference of the tire from the first sealed termination but is at least 0.5-1 inch from the first termination (measurement performed on an inflated C-shaped inner tube).

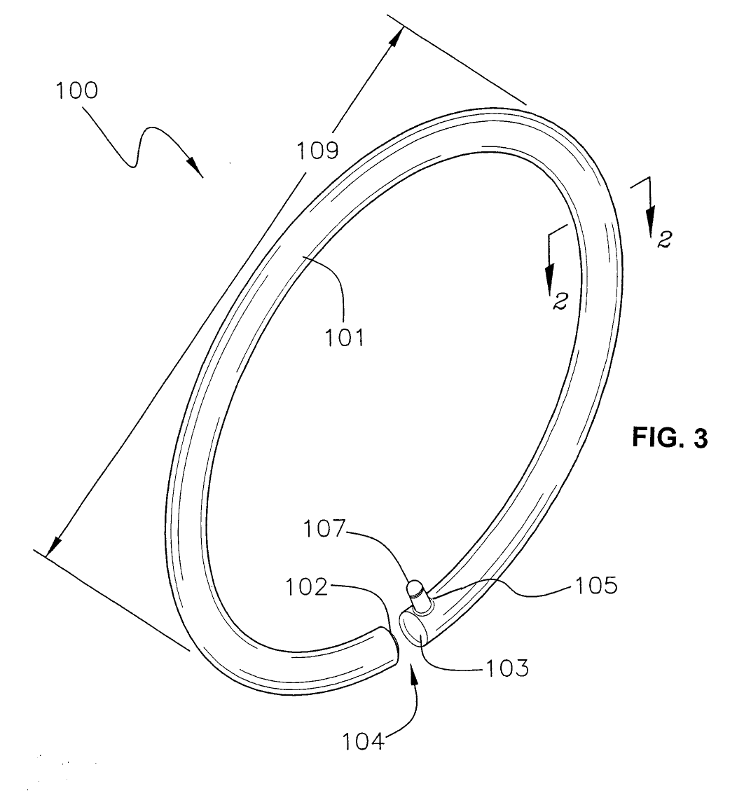

In some embodiments, the inner tube comprises a threaded stem valve 105 disposed on the surface of the hermetically sealed compartment at the very tip (i.e., at the edge) of the first sealed termination, and it comprises a threaded stem valve cap 107 that forms a hermetic seal when coupled to the threaded stem valve 105, see for example FIG. 3.

One of the major advantages of this invention is that the stem valve 105 is located near or at the tip of the first sealed termination. The location of the stem valve 105 allows the user to hook the stem valve 105 into the wheel assembly and to spin the tire in one single direction as the inner tube 100 is inserted into the tire. Other inventions previously described only allow for, for example, half of the replacement tube to be inserted into the tire in one direction. In other words, once the stem valve of the prior art has been hooked in, the user can only feed in either the first half or the second half of the inner tube into the tire by spinning the tire in one direction. Once that half has been inserted into the tire, the user must go back and feed through the other half of the tube by spinning the tube in the opposite direction.

In some embodiments, the first and second sealed terminations of the hermetically sealed compartment are flat. The advantage the flat terminations have over prior art is they provide for a smooth mating of the two end terminals. In other words, when the C-shaped inner tube 100 is fully inflated, the two flat sealed terminations will perfectly abut, creating a continuous ring. Sealed terminations that are bulged and not flat will not perfectly abut, and thus will not create a perfect continuous ring.

In some embodiments, the hermetically sealed compartment comprises an inner wall, an outer wall, and a cavity. The C-shaped inner tube 100 may be used with a variety of pneumatic tires, including, for example, tires of trucks, cars, motorcycles, and bicycles. In some embodiments, the C-shaped inner tube 100 comprises a load rating and a pounds-per-square-inch (PSI) rating equal to or greater than a standard inner tube. The threaded stem valve 105 may be used with a standard air compressor and a standard tire pump.

In some embodiments, the hermetically sealed compartment comprises primarily natural rubber. In some embodiments, the hermetically sealed compartment comprises primarily synthetic rubber.

In some embodiments, the hermetically sealed compartment further comprises an outer diameter 109 of at least twelve (12) inches (when fully inflated with the first and second end abutting). In some embodiments, the hermetically sealed compartment further comprises an outer diameter 109 of about thirty-six (36) inches. In some embodiments, the hermetically sealed compartment comprises a wall thickness of at about one sixty-fourth ( 1/64) inch to about one (1) inch. Herein after, the term “about” means ±10%.

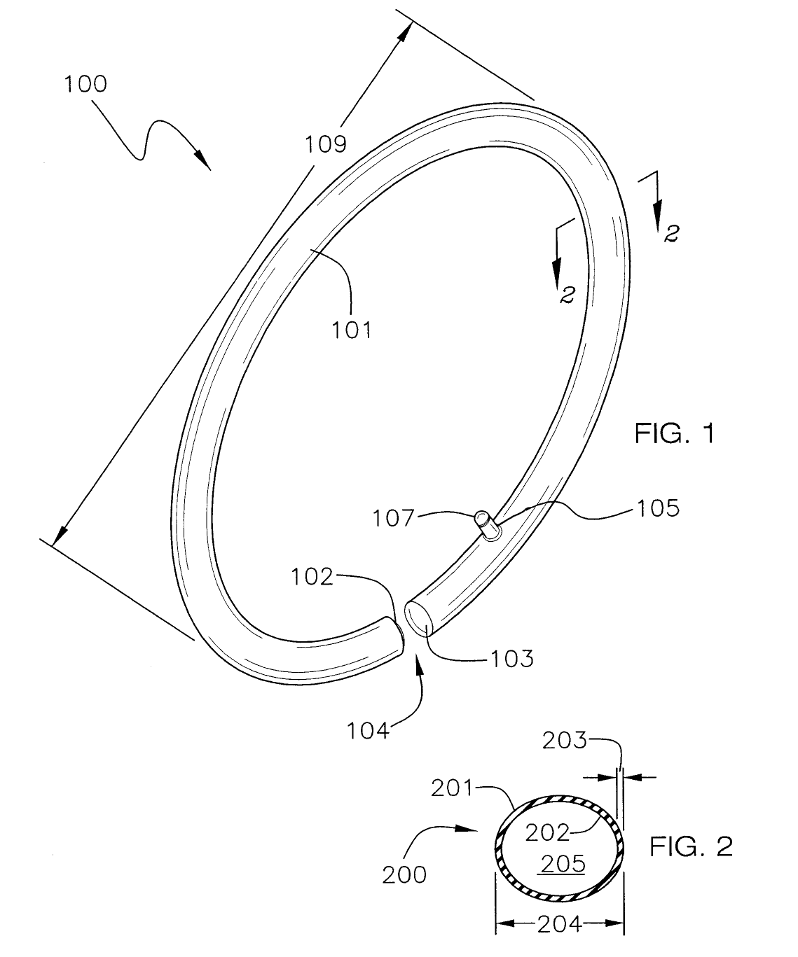

FIG. 1 illustrates a front perspective view of a C-shaped inner tube 100 for use with a pneumatic tire in accordance with one aspect of the present invention. Hermetically sealed compartment 101 comprises a first sealed termination 102 and a second sealed termination 103, both of which are flat. The C-shaped inner tube 100 comprises stem valve 105 disposed on a surface of hermetically sealed compartment 101 at the very tip of the first sealed termination 102. The stem valve 105 comprises an opening (not expressly shown) on the hermetically sealed compartment 101 for the insertion of air into the hermetically sealed compartment 101. The stem valve 105 further comprises a threaded aperture (not shown) on the opposite end of the valve aperture (not expressly shown). This aperture may be used with a variety of devices for inflation of the hermetically sealed compartment 101 including, but not limited to, air compressors, hand pumps, and canned air.

The C-shaped inner tube 100 further comprises stem valve cap 107. The stem valve cap 107 creates a hermetic seal when tightly coupled to the threaded aperture (not shown) of the stem valve 105. When the hermetically sealed compartment 101 is filled with air, it takes on an annular shape. The first sealed termination 102 then abuts second sealed termination 103, and no separation exists between first sealed termination 102 and second sealed termination 103. Further, as the hermetically sealed compartment 101 becomes inflated, the inner tube 100 forms a contiguous annular shape with first sealed termination 102 abutting second sealed termination 103, giving inner tube 100 a strong, contiguous, annular shape. In some embodiments, the first sealed termination 102 can be bound to second sealed termination 103 when hermetically sealed compartment 101 is fully inflated. Binding may be achieved in a variety of forms including, but not limited to, glue, reusable adhesive, magnets, a plurality of interlocking apertures and protrusions, and a hook-and-loop material.

FIG. 2 illustrates a cross section perspective view of a C-shaped inner tube 200. The inner tube 200 comprises an outer wall 201, inner wall 202 (where the “inner circumference” is determined), wall thickness 203, cross section diameter 204, and inner cavity 205. Wall thickness 203 may be provided in various thicknesses and in one embodiment is one sixty-fourth ( 1/64) of an inch. In another embodiment, the wall thickness 203 is one inch. Further, cross section diameter 204 may be provided in various diameters and in one embodiments is one half (½) of an inch. In another embodiment, cross section diameter 204 is twenty (20) inches. During use, a user inflates the C-shaped inner tube 200. As the inner tube 200 inflates, the inner cavity 205 becomes filled with air, pushing outer wall 201 and inner wall 202 outward, causing outer wall 201 and inner wall 202 to expand concentrically. As inner cavity 205 fills with air, inner cavity 205 generally takes on a circular shape, forming a circular cross section generally illustrated at 200. Inner wall 201 and outer wall 202 may be formed of a variety of materials, including but not limited to natural rubber and synthetic rubber.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A C-shaped inner tube for use with a pneumatic tire comprising:
(a) a hermetically sealed compartment comprising a first sealed termination and a second sealed termination; and
(b) a threaded stem valve disposed on a surface of the hermetically sealed compartment, wherein the stem valve is located at a distance less than one fourth (¼) of the C-shaped inner tube's inner circumference as measured from the first sealed termination.

2. The inner tube of claim 1 wherein the hermetically sealed compartment comprises an inner wall, an outer wall, and a cavity.

3. The inner tube of claim 1 wherein the hermetically sealed compartment comprises a circular cross section when the hermetically sealed compartment is filled with air.

4. The inner tube of claim 1, wherein the first and second sealed terminations are flat.

5. The inner tube of claim 1, wherein the threaded stem valve is located at the very tip of the first sealed termination.

6. The inner tube of claim 1, wherein the threaded stem valve is located at a distance that is less than one eighth (⅛) of the pneumatic tire's circumference from the first sealed termination.

7. The inner tube of claim 1, wherein the threaded stem valve is located at a distance that is less than one sixteenth ( 1/16) of the pneumatic tire's circumference from the first sealed termination.

8. The inner tube of claim 1 wherein the threaded stem valve cap couples to the threaded stem valve, operable to form a hermetic seal.

9. The inner tube of claim 1 wherein the threaded stem valve comprises a standard tire stem valve operable to be used with a standard air compressor and a standard tire pump.

10. The inner tube of claim 1 wherein the inner tube comprises a load rating and a pounds-per-square-inch (PSI) rating equal to or greater than a standard inner tube.

11. The inner tube of claim 1 wherein the inner tube may be folded into a compacted position when substantially all of the air has been removed from the hermetically sealed compartment.
